(19) United States
(12) Patent Application Publication
(10) Pub. No.: US 2011/0206871 A1
(43) Pub. Date: Aug. 25, 2011

(54) INK JET RECORDING MEDIUM AND METHOD OF MANUFACTURING THE SAME

(75) Inventor: Ryoichi NAKANO, Kanagawa (JP)

(73) Assignee: FUJIFILM CORPORATION, Tokyo (JP)

(21) Appl. No.: 13/027,279

(22) Filed: Feb. 15, 2011

(30) Foreign Application Priority Data
Feb. 19, 2010 (JP) 2010-035453

(51) Int. Cl. B41M 5/50; B05D 7/00

(52) U.S. Cl. 428/32.21; 428/32.34; 427/407.1

(57) ABSTRACT

An ink jet recording medium includes: a gas impermeable support, an undercoat layer that is provided on the gas impermeable support and contains from 0.01 g/m² to 1 g/m² of cationic polyvinyl alcohol, and an ink-receiving layer that is provided on the undercoat layer and contains inorganic fine particles and a water-soluble resin.

### CROSS-REFERENCE TO RELATED APPLICATION

This application claims priority under 35 USC 119 from Japanese Patent Application No. 2010-035453, filed on Feb. 19, 2010, the disclosure of which is incorporated by reference herein.

### BACKGROUND OF THE INVENTION

1. Field of Invention

The present invention relates to an ink jet recording medium and a method of manufacturing the same.

2. Description of the Related Art

With realization of high-resolution ink jet printers and advances in hardware (apparatuses), in recent years, various media for ink jet recording have been developed, and “photograph-like” high-quality recorded images can be obtained.

Particularly, media for ink jet recording are required to have characteristics of, for example, glossiness, surface smoothness, and a texture like developing paper similar to that of silver halide photography, in addition to normal characteristics.

As a method of manufacturing an ink jet recording medium that satisfies a part of the above requirements and exhibits excellent recording suitability such as glossiness and reduced image bleeding, there is disclosed a method of manufacturing an ink jet recording medium including forming a coating layer on a gas permeable support by coating with a coating liquid which contains a temperature-sensitive polymer compound and a pigment; and applying an ink fixing agent containing a cationic resin on the formed coating layer (see, for example, Japanese Patent Application Laid-Open (JP-A) No. 2006-103315).

As a support for an image recording medium capable of forming sharp and bright, “photograph-like” high-quality recorded images with a recording face having a high specular reflectance and a method of manufacturing the same, a support for an image recording medium having a substrate and a layer including a pearlescent pigment, hydrophilic synthetic smectite, and a water-soluble polymer and a method of manufacturing the same are disclosed (see, for example, JP-A No. 2005-96284).

### SUMMARY OF THE INVENTION

However, even in the ink jet recording media disclosed in JP-A No. 2006-103315 and JP-A No. 2005-96284, satisfactory characteristics with respect to the surface conditions and image clarity have not been obtained yet.

The present invention has been made in view of the above circumstances and provides an ink jet recording medium and a method of manufacturing the same.

According to a first aspect of the invention, there is provided an ink jet recording medium including: a gas impermeable support, an undercoat layer that is provided on the gas impermeable support and contains from 0.01 g/m² to 1 g/m² of cationic polyvinyl alcohol, and an ink-receiving layer that is provided on the undercoat layer and contains inorganic fine particles and a water-soluble resin.

According to a second aspect of the invention, there is provided a method of manufacturing an ink jet recording medium including: forming an undercoat layer by applying an undercoat-layer-coating liquid containing cationic polyvinyl alcohol on a gas impermeable support; and forming an ink-receiving layer by applying an ink-receiving-layer-coating liquid containing inorganic fine particles and a water-soluble resin on the undercoat layer.

### DETAILED DESCRIPTION OF THE INVENTION

Hereinafter, the ink jet recording medium and the method of manufacturing the same according to the present invention are described in detail.

<Ink Jet Recording Medium>

The ink jet recording medium according to the present invention includes a gas impermeable support, an undercoat layer that is provided on the gas impermeable support and contains from 0.01 g/m² to 1 g/m² of cationic polyvinyl alcohol, and an ink-receiving layer that is provided on the undercoat layer and contains inorganic fine particles and a water-soluble resin.

When the ink jet recording medium includes the undercoat layer which is provided on the gas impermeable support and contains from 0.01 g/m² to 1 g/m² of cationic polyvinyl alcohol, an ink jet recording medium having excellent image clarity and reduced surface defects can be realized.

In addition, an ink jet recording medium having favorable surface conditions and excellent image clarity owing to suppression of air engulfment in manufacturing the ink jet recording medium can be manufactured.

Hereinafter, materials used for the ink jet recording medium according to the present invention are described.

Gas Impermeable Support

The ink jet recording medium according to the present invention includes a gas impermeable support as a support.

In the present invention, the gas impermeable support refers to a support having gas permeability of 2000 seconds or more, and preferably 3000 seconds or more. The gas permeability represents gas permeability that is generally known as an evaluation index of the porosity of, for example, paper or non-woven fabric. Gas permeability represents the time necessary for 100 ml of air to pass through a test specimen having an area of 645 mm² as defined by JIS P8117 (test method for determining gas permeability of paper and paper board).

Examples of the gas impermeable support include a plastic film such as of polyethylene terephthalate, polyvinyl chloride, polycarbonate, polyethylene, or polypropylene; a white film; and a synthetic paper such as YUPO (manufactured by Yupo Corporation), which is prepared by stretching polypropylene and then performing a special processing on the stretched polypropylene.

For example, a gas impermeable resin-coated sheet obtained by coating, with a gas impermeable resin, a support which is made of a gas permeable support may be used. Examples of the gas impermeable resin include a resin containing, for example, polyethylene, polypropylene, cellulose diacetate, or a mixture thereof as the main component. A polyolefin resin-coated paper having a resin-coated layer in which polyolefin resin is laminated on a paper substrate (so-called RC paper) is preferable in light of excellent image clarity and reduced surface defects. Particularly, a polyethylene-resin-coated sheet in which titanium oxide has been kneaded is preferably used due to its photograph-like texture.

Examples of the gas permeable support include a paper substrate, a gas permeable resin film and a gas permeable sheet material. The paper substrate is favorably used in view of excellent gas permeability, ease of handling as a recording body and ease of disposal and recycling.

Commonly used known paper substrates may be used as the paper substrate, to an extent that the effects of the present invention are not impaired. Examples of the paper substrate include high-quality paper, art paper, coated paper, cast coated paper, craft paper, baryta paper, paper board, impregnated paper, and deposition paper. In addition, for example, acid paper or neutralized paper used for common coated paper or the like may also be appropriately used.

The thickness of the gas impermeable support is not particularly limited, but is preferably from 50 μm to 300 μm in terms of ease of handling.

In addition, in order to improve wettability and adhesion properties, the surface of the support is preferably treated by, for example, corona discharge treatment, a glow discharge treatment, a flame treatment, an ultraviolet irradiation treatment, or the like.

Next, base paper used in a paper support such as a resin coated paper is described.

The main raw material of the base paper is wood pulp. When making the base paper, a synthetic pulp or a synthetic fiber may be optionally used in addition to the wood pulp. The synthetic pulp may be made of, for example, polypropylene, and the synthetic fiber may be, for example, a nylon fiber or a polyester fiber. As the wood pulp, any of LBKP, LBSP, NBKP, NBSP, LDP, NDP, LUKP or NUKP may be used. It is preferable to increase the total amount of LBKP, NBSP, LBSP, NDP and LDP, which have high contents of short fibers. However, the proportion of LBSP and/or LDP is preferably from 10% by mass to 70% by mass.

The pulp is preferably a chemical pulp (such as sulfate salt pulp or sulfite pulp), which has a low impurity content. A pulp of which whiteness is improved by bleaching is also useful.

To the base paper, one or more of the following may be added as necessary: a sizing agent such as a higher fatty acid or an alkylketene dimer, a white pigment such as calcium carbonate, talc or titanium oxide, a paper-strength enhancing additive such as starch, polyacrylamide or polyvinyl alcohol, a fluorescent brightener, a moisturizing agent such as polyethylene glycol, a dispersant, a softener such as quaternary ammonium, or the like.

The freeness, according to CSF (Canadian Standard Freeness), of the pulp used for paper-making is preferably from 200 mL to 500 mL. In regard to the fiber length after beating, the total sum of the percent by mass of the pulp remaining on a 24-mesh screen and the percent by mass of the pulp remaining on a 42-mesh screen according to JIS P-8207 (which is incorporated herein by reference) is preferably from 30% to 70% by mass. Further, the percent by mass of the pulp remaining on a 4-mesh screen is preferably 20% by mass or less.

The basis weight of base paper is preferably from 30 g/m² to 250 g/m², particularly preferably from 50 g/m² to 200 g/m². The thickness of the base paper is preferably from 40 μm to 250 μm. High smoothness may be imparted to the base paper by subjecting the base paper to calender treatment during or after papermaking. The base paper density is generally from 0.7 g/m³ to 1.2 g/m³ (according to JIS P-8118, which is incorporated herein by reference). Furthermore, the stiffness of the base paper is preferably from 20 g to 200 g under conditions defined by JIS P-8143, which is incorporated herein by reference.

The base paper surface may be coated with a surface sizing agent, which may be selected from the above-described sizing agent that may be incorporated into the interior of the base paper.

The pH of the base paper is preferably from 5 to 9 as measured according to the hydrothermal extraction method defined by JIS P-8113, which is incorporated herein by reference.

The polyethylene covering the front and rear surfaces of the base paper mainly includes a low-density polyethylene (LDPE) and/or a high-density polyethylene (HDPE), and optionally includes a small amount of other polymers such as LLDPE or polypropylene.

In particular, the polyethylene layer at a side on which the ink receiving layer is to be formed preferably includes, in polyethylene, at least one of rutile-titanium oxide, anatase-titanium oxide, a fluorescent brightener, or ultramarine, which are commonly used in photographic papers, whereby opacity, whiteness and hue are improved. The content of titanium oxide is preferably in a range of from about 3% by mass to about 20% by mass, and more preferably in a range of from 4% by mass to 13% by mass, with respect to the polyethylene. The thickness of each of the polyethylene layer on the front side and the polyethylene layer on the rear side is not particularly limited, but is preferably in a range of from 10 μm to 50 μm.

The polyethylene-coated paper may be glossy paper, or paper having a matte or silky surface that is similar to that of common photographic printing paper and that has been formed by performing surface-finishing treatment when coating polyethylene on base paper by melt-extrusion.

The support may have a back coating layer. Examples of components that can be added to the back coating layer include a white pigment, an aqueous binder, and other components.

Examples of the white pigment that may be contained in the back coating layer include a white inorganic pigment, such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate, or magnesium hydroxide; and an organic pigment, such as a styrene-based plastic pigment, an acrylic plastic pigment, polyethylene, microcapsule, urea resin, or melamine resin.

Examples of the aqueous binder that may be used in the back coating layer include a water-soluble polymer, such as styrene/maleate copolymer, styrene/acrylate copolymer, polyvinyl alcohol, silanol-modified polyvinyl alcohol, starch, cationized starch, casein, gelatin, carboxymethylcellulose, hydroxyethyl cellulose, or polyvinyl pyrrolidone; and water-dispersible polymer, such as styrene butadiene latex, or acrylic emulsion.

Examples of the other components that may be contained in the back coating layer include a defoamer, an anti-foaming agent, a dye, a fluorescent brightener, a preservative, and a water-resistant additive.

Undercoat Layer

The undercoat layer according to the present invention includes at least one cationic polyvinyl alcohol in which a cationic group is contained in a polyvinyl alcohol (hereinafter, referred to as a cationic PVA), and preferably further includes an additional alcohol other than the cationic polyvinyl alcohol from the viewpoint of reducing surface defects. In addition, if necessary, the undercoat layer may include an additional additive. Unlike the ink-receiving layer, the undercoat layer includes the cationic PVA as a main component.

In the present invention, the mechanism by which an effect of remarkably suppressing surface defects is achieved due to including the cationic PVA in the undercoat layer is not clear, but it can be assumed to be as follows.

It is assumed that, when the undercoat layer formed on the gas impermeable support includes the cationic PVA, adhesion between the ink-receiving layer and the undercoat layer is improved, as a result of which, incorporation of air can be suppressed during coating with an ink-receiving-layer-coating liquid (ink-receiving layer-forming liquid), whereby defects in the surface conditions are suppressed, and, in particular, defects in the surface conditions, which become a problem in applying the coating liquid at a high speed, can be remarkably suppressed.

When the amount of the cationic PVA contained in the undercoat layer is adjusted to be within the range defined in the present specification, surface defects of the ink jet recording medium can be suppressed while achieving favorable anti-bleed properties of the ink jet recording medium. It is thought that, as the application amount of the cationic PVA is increased, anionic dyes contained in ink are more mordanted with the cationic PVA contained in the undercoat layer, as a result of which bleed is more likely to occur at high humidity due to high water-solubility of the cationic dye.

(Cationic Polyvinyl Alcohol)

The undercoat layer according to the present invention includes at least one cationic polyvinyl alcohol in which a cationic group is contained in the molecule of the polyvinyl alcohol (PVA) (hereinafter, referred to as “cationic PVA”) at an amount of from 0.01 g/m² to 1 g/m².

The undercoat layer contains the cationic PVA in a range of from 0.01 g/m² to 1 g/m²; however, the undercoat layer preferably contains the cationic PVA in a range of from 0.02 g/m² to 0.5 g/m², and more preferably from 0.05 g/m² to 0.5 g/m², from the standpoints of improving compatibility and adhesion to the ink-receiving layer and improving the surface conditions.

The undercoat layer containing a cationic PVA at an amount of from 0.01 g/m² to 1 g/m² has a tendency to improve the compatibility and adhesion of the undercoat layer to the ink-receiving layer and also reduce surface defects.

As a method of manufacturing the cationic PVA, the method described in, for example, Japanese Examined Patent Application Publication (JP-B) No. 62-34242 may be used. Specific examples thereof include a method in which polyvinyl acetate is prepared by copolymerizing vinyl acetate and a monomer containing a quaternary ammonium salt such as trimethyl-3-((meth)acrylamide propyl) ammonium chloride, by a known polymerization method such as bulk polymerization, solution polymerization, suspension polymerization, or emulsion polymerization, a methanol solution of sodium hydroxide is added to the resulting polyvinyl acetate, and the mixture is saponified and dried; and a method including copolymerizing vinyl acetate and a monomer containing an amino group such as dimethyl aminoethyl(meth)acrylamide, quaternizing the amino group by adding a known quaternizing agent such as methyl chloride, and drying the quaternized amino group.

The molar ratio of the cationic groups present in the cationic PVA relative to the total mole number of structural units constituting the cationic polymer is from 0.01 mol % to 20 mol %, preferably from 0.03 mol % to 10 mol %, and more preferably from 0.05 mol % to 5 mol %. When the molar ratio of the cationic groups present in the cationic PVA relative to the total mole number of structural units constituting the cationic polymer is less than 0.01 mol %, an effect of cationizing a molecule decreases. When the molar ratio of the cationic groups present in the cationic PVA relative to the total mole number of structural units constituting the cationic polymer exceeds 20 mol %, a further effect is not exhibited, while production cost increases.

Preferable examples of the cationic PVA include a PVA that is obtained by copolymerizing vinyl ester and a monomer represented by Formula (1) described in JP-B No. 62-34242. As a method of manufacturing the copolymer, the manufacturing method described in JP-B No. 62-34242 may be used.

Examples of the vinyl ester include vinyl acetate, vinyl propionate, and vinyl formate, and vinyl acetate is particularly preferred.

Examples of commercially available products of the cationic PVA in the present invention include C-118, C-506, C-318 (all manufactured by Kuraray Co., Ltd.), GOHSEFIMER C-670, GOHSEFIMER C-820, GOHSEFIMER K-200, GOHSEFIMER K-210 (all manufactured by Nippon Synthetic Chemical Industry Co., Ltd.). Among the above, GOHSEFIMER K-210, C-506, C-318, and GOHSEFIMER C-670 are preferred.

The degree of polymerization of the cationic PVA is preferably 1000 or less, more preferably 800 or less, and particularly preferably 500 or less. When the degree of polymerization exceeds 1000, viscosity of an undercoat-layer-coating liquid increases, whereby application of the undercoat-layer-coating liquid is difficult and, furthermore, the flatness of a coated surface deteriorates. In addition, the degree of polymerization is preferably 100 or more, and more preferably 300 or more. When the degree of polymerization is less than 100, adhesion of the undercoat layer decreases. Here, the degree of polymerization of the cationic PVA refers to a viscosity average polymerization degree as determined from the viscosity of an acetone solution of a polyvinyl acetate which prepared by acetylating the cationic PVA.

(Solvent)

The undercoat layer can be obtained by applying, to the gas impermeable support, an undercoat-layer-coating liquid containing the above components.

With respect to a solvent of the undercoat-layer-coating liquid, an additional alcohol other than the cationic polyvinyl alcohol and a mixed solvent of the additional alcohol and water are preferred, and the details thereof are described in the section of a method regarding manufacturing the ink jet recording medium.

The undercoat layer may contain, for example, a surfactant, a water-soluble resin other than PVA, or the like, so long as the effects of the present invention are not impaired.

The thickness of the undercoat layer is not particularly limited, but, from the viewpoints of surface defects (cracking) and brittleness of the ink-receiving layer and the adhesion of the ink-receiving layer, the thickness of the undercoat layer is preferably from 0.01 μm to 1 μm, more preferably from 0.02 μm to 0.8 μm, and still more preferably from 0.05 μm to 0.5 μm. The undercoat layer having the thickness of the above range is favorable since the effects of reducing surface defects according to the present invention can be remarkably observed.

Ink-Receiving Layer

The ink-receiving layer according to the present invention contains at least one inorganic fine particle and at least one water-soluble resin.

### (Inorganic Fine Particles)

The ink-receiving layer of the present invention includes inorganic fine particles.

Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, boehmite and pseudoboehmite. In particular, silica fine particles are particularly preferred.

Since the silica fine particles have a very large specific surface area, the ink absorptivity and ink retaining capability are high. Since the silica fine particles have a low refractive index, transparency can be imparted to the ink-receiving layer formed using the silica fine particles that have been dispersed to a suitable particle diameter, whereby a high color density and favorable color-forming property can be achieved. The transparency of an ink-receiving layer is important in applications in which transparency is required such as application to an OHP, as well as when applied to recording sheets such as photo glossy paper in light of obtaining a high color density, favorable coloring gloss, and image clarity.

The average primary particle diameter of the inorganic fine particles is preferably 20 nm or less, more preferably 15 nm or less, and particularly preferably 10 nm or less. When the average primary particle diameter is 20 nm or less, ink-absorbing characteristics can be effectively improved, and, at the same time, glossiness on the surface of the ink-receiving layer can be improved.

The specific surface area of the inorganic fine particles as measured according to the BET method is preferably 200 m²/g or more, more preferably 250 m²/g or more, and still more preferably 380 m²/g or more. When the specific surface area of the inorganic fine particles is 200 m²/g or more, the transparency of the ink-receiving layer is high, and the density of printed images can be maintained at a high level.

The BET method mentioned in the present invention is one of the methods of measuring the surface area of powder employing a gas-phase absorption method, and the total surface area per 1 g of a specimen, namely the specific surface area, is obtained from the absorption isotherm. A widely-used gas to be adsorbed (adsorption gas) is nitrogen gas, and a method of measuring the absorbed amount from a change in the pressure or volume of the absorption gas is most commonly used. The most well-known expression that expresses an isotherm of multimolecular absorption is the equation of Brunauer, Emmett, and Teller method, which is called BET method and is widely used for determining the surface area. The gas absorption amount is obtained based on the BET equation, and the surface area can be determined by multiplying the adsorption amount by the surface area occupied by one absorption molecule.

In particular, silica fine particles have silanol groups on surface thereof. The particles easily adhere to each other through hydrogen bonding of the silanol groups, and particles are adhered to one another also via interaction between the water-soluble resin and the silanol groups. Hence, when the average primary particle diameter of silica fine particles is 20 nm or less as described above, the porosity of the ink-receiving layer is high, a structure with high transparency is formed, and ink absorption characteristics are effectively improved.

Generally, the silica fine particles are roughly classified into wet process silica particles and dry process (fumed) silica particles according to manufacturing method thereof. In the wet process, a method of producing hydrous silica by forming active silica by acid decomposition of silicate, polymerizing the active silica to a certain degree, and allowing the resultant polymerized product to aggregate and precipitate, is widely used. In fumed process, a method of producing anhydrous silica by high-temperature fumed hydrolysis of a silicon halide (flame hydrolysis) or a method in which silica sand and coke are subjected to heat reduction and evaporation by arc in an electric furnace and the resultant product is oxidized by air (arc process), are widely used. The “fumed silica” as used herein refers to anhydrous silica fine particles obtained by the fumed process.

The fumed silica differs from the hydrous silica in density of silanol groups on the surface thereof, the presence or absence of pores, and the like, and exhibits different properties from those of the hydrous silica. The fumed silica is suitable for forming three-dimensional structures having a high porosity, though the reason thereof is not clear. It may be because, whilst the hydrous silica fine particles tend to closely aggregate (i.e., form aggregates) owing to high silanol densities of from 5 groups/nm² to 8 groups/nm² on the fine particle surface, the fumed silica particles form loose aggregate (i.e., flocculates) owing to low silanol densities of from 2 groups/nm² to 3 groups/nm² on the fine particle surface, which results in formation of a highly-porous structure.

In the present invention, the fumed silica fine particles (anhydrous silica) obtained by the dry process described above are preferable, and silica fine particles having the silanol densities of from 2 groups/nm² to 3 groups/nm² on the fine particle surface are more preferable.

The inorganic fine particles most preferably used in the present invention are fumed silica having a specific surface area of 200 m²/g or more as determined by the BET method.

(Water-Soluble Resin)

Examples of the water-soluble resin include resins having a hydroxyl group as a hydrophilic structural unit, such as polyvinyl alcohol (PVA), cation-modified polyvinyl alcohol, anion-modified polyvinyl alcohol, silanol-modified polyvinyl alcohol, and polyvinyl acetal, cellulose resins (for example, methyl cellulose (MC), ethyl cellulose (EC), hydroxyethyl cellulose (HEC), carboxymethyl cellulose (CMC), and hydroxypropyl cellulose (HPC)), chitins, chitosans and starch; resins having a hydrophilic ether bond such as polyethylene oxide (PEO), polypropylene oxide (PPO), polyethylene glycol (PEG), and polyvinyl ether (PVE); and resins having a hydrophilic amide group or an amide bond such as polyacrylamide (PAAM), and polyvinyl pyrrolidone (PVP). Further examples of the water-soluble resin include resins having a carboxyl group as a dissociative group, such as salts of polyacrylic acid, maleic acid resins, salts of alginic acid and gelatins.

The content of the water-soluble resin in the present invention is preferably from 9% by mass to 40% by mass, and more preferably from 12% by mass to 33% by mass with respect to the total solid mass of the ink-receiving layer, from the viewpoints of preventing a decrease in film strength or an occurrence of cracking while drying, which are induced by an excessively low content of the water-soluble resin, and from the viewpoints of preventing reduction ink-absorbency that results from decrease in porosity due to an increased tendency for pores to be clogged by the resins, which is induced by excessively high content of the water-soluble resin.

The water-soluble resin has hydroxyl groups in the structural unit, and the hydroxyl groups and the silanol groups on the surface of the silica fine particles form hydrogen bonding, whereby a three-dimensional network structure having secondary particles of the silica fine particles as chain units is easily formed. It is considered that a porous-structured ink-receiving layer having high porosity can be formed by the formation of such a three-dimensional network structure.

In the ink jet recording medium, the porous ink-receiving layer obtained in the above manner can absorb ink rapidly by capillary action and form excellent true-circularly dots without ink bleeding.

(Content Ratio of Inorganic Fine Particles to Water-Soluble Resin)

The content ratio of the inorganic fine particles (preferably silica fine particles; x) to the water-soluble resin (y) (PB ratio (x/y), the mass of the inorganic fine particles with respect to 1 part by mass of the water-soluble resin in the present invention) also has a large influence on the film structure of the ink-receiving layer. In other words, as the PB ratio increases, porosity, pore volume and surface area (per unit mass) increase. Specifically, the PB ratio (x/y) is preferably from 1.5/1 to 10/1 from the viewpoints of preventing a decrease in film strength and cracks while drying, which are induced by excessively high PB ratios, and from the viewpoints of preventing reduction in ink-absorbency that results from decrease in porosity due to an increased tendency for pores to be clogged by the resins, which is induced by excessively low PB ratios.

When passing through the transport system of an inkjet printer, the inkjet recording medium is subjected to stress in some cases; therefore, the ink-receiving layer preferably has sufficient film strength. The sufficient strength of the ink-receiving layer is favorable also from the standpoint of avoiding the occurrence of cracking and detachment of the ink-receiving layer when the recording medium is cut into sheets. In view of these cases, the mass ratio (x/y) is preferably 5/1 or less, while it is preferably 2/1 or more from the viewpoint of ensuring capability of high-speed ink absorption in inkjet printers.

For example, when an ink-receiving-layer-coating liquid prepared by completely dispersing anhydrous silica particles having an average primary particle diameter of 20 nm or less and a water-soluble resin at a mass ratio (x/y) of from 2/1 to 5/1 in a solution is applied onto a support and the resultant ink-receiving layer is dried, a three-dimensional network structure is formed which has secondary particles of the anhydrous silica particles as network chains, whereby a light-transmitting porous film having an average pore diameter of 30 nm or less, a porosity of from 50% to 80%, a specific pore volume of 0.5 ml/g or more, and a specific surface area of 100 m²/g or more can be easily formed.

(Crosslinking Agent)

The ink-receiving layer in the present invention preferably contains a crosslinking agent. The ink-receiving layer according to the present invention is preferably a porous layer cured through crosslinking reaction of the water-soluble resin by the crosslinking agent.

As the crosslinking agent, a crosslinking agent which is preferable in relation to the water-soluble resin included in the ink-receiving layer in the present invention may be appropriately selected. In particular, from the standpoint of rapidness of crosslinking reaction, a boron compound is preferred. Examples thereof include borax, boric acid, borates (such as orthoborate, InBO₃, ScBO₃, YBO₃, LaBO₃, Mg₃(BO₃)₂, CO₃(BO₃)₂), diborates (such as Mg₂B₂O₅, CO₂B₂O₅), metaborates (such as LiBO₂, Ca(BO₂)₂, NaBO₂, KBO₂), tetraborates (such as Na₂B₄O₇.10H₂O), pentaborates (such as KB₅O₈.4H₂O, CsB₅O₅), and hexaborates (such as Ca₂B₆O₁₁.7H₂O). Of these, from the viewpoint of rapidness of crosslinking reaction, borax, boric acid, and borates are preferred, and boric acid or borate is particularly preferred and it is most preferable to use such a crosslinking agent as a mixture with polyvinyl alcohol, which is a water-soluble resin.

In the present invention, the crosslinking agent is preferably included at an amount of from 0.05 parts by mass to 0.50 parts by mass, and more preferably from 0.08 parts by mass to 0.30 parts by mass, with respect to 1.0 part by mass of the water-soluble resin (for example, polyvinyl alcohol) in the present invention. When the content of the crosslinking agent is in the above range, the water-soluble resin of the present invention is effectively crosslinked thereby preventing cracks or the like.

When the gelatin is used as the water soluble resin, crosslinking agents may be the following compounds other than the boron compounds.

Examples of crosslinking agents include aldehyde compounds, such as formaldehyde, glyoxal and gultaraldehyde; ketone compounds, such as diacetyl and cyclopentanedione; active halogen compounds, such as bis(2-chloroethylurea)-2-hydroxy-4,6-dichloro-1,3,5-triazine and sodium salts of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins;

isocyanate compounds, such as 1,6-hexamethylene diisocyanate; the aziridine compounds described in U.S. Pat. Nos. 3,017,280 and 2,983,611; the carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate and chromium acetate; polyamine compounds, such as tetraethylenepentamine; hydrazide compounds, such as adipic acid dihydrazide; and low-molecular compounds or polymers each having at least two oxazoline groups. The crosslinking agent may be used alone or may be used in combination of two or more kinds thereof.

(Mordant)

In addition to the inorganic fine particles and water-soluble resin, it is preferable that the ink-receiving layer further includes a mordant. Examples of the mordant include an inorganic mordant such as a water-soluble metal compound; and an organic mordant such as a cationic polymer, and a water-soluble multivalent metal salt or a nitrogen-containing organic cationic polymer is favorably used.

Examples of the water-soluble metal compound include a water-soluble salt of a metal selected from calcium, barium, manganese, copper, cobalt, nickel, aluminum, iron, zinc, zirconium, chromium, tungsten, and molybdenum. Here, the “water-soluble” in the water-soluble metal compound means that the compound dissolves in water at 20° C. in an amount of 1% by mass or more.

Among the water-soluble metal compounds, a tri- or more valent metal compound is preferable, and an aluminum compound and a compound which contains a metal belonging to group 4A of the periodic table (for example, zirconium and titanium) is preferable, and a zirconium compound and an aluminum compound are more preferable. A water-soluble aluminum compound is particularly preferable.

As the water-soluble aluminum compound, for example, aluminum chloride or a hydrate thereof (such as aluminum chloride hexahydrate), aluminum sulfate or a hydrate thereof, ammonium alum, aluminum sulfite, aluminum thiosulfate, aluminum nitrate nonahydrate, aluminum acetate, aluminum lactate, and basic aluminum thioglycolate are known. Furthermore, a basic poly aluminum hydroxide compound, which is an inorganic aluminum-containing cationic polymer, (hereinafter, also referred to as “basic poly aluminum chloride” or “poly aluminum chloride”) is known and is preferably used. The basic poly aluminum hydroxide compound refers to a water-soluble poly aluminum hydroxide which has a main component represented by the following formulae 1, 2 or 3, and stably contains a basic polymeric polynuclear condensed ion, such as [Al₆(OH)₁₅]³⁺, [Al₈(OH)₂₀]⁴⁺, [Al₃(OH)₃₄]⁵⁺, and [Al₂₁(OH)₆₀]³⁺.

[Al₂(OH)ₙCl₆₋ₙ]ₘ formula 1

[Al(OH)₃]ₙAlCl₃ formula 2

Alₙ(OH)ₘCl₍₃ₙ₋ₘ₎(0<m<3n) formula 3

Such basic poly aluminum hydroxide compounds are commercially available under a trade name of poly aluminum chloride (PAC) as a water treatment agent from Taki Chemical Co., Ltd., poly aluminum hydroxide (Paho) from Asada Chemical Industry Co., Ltd., HAP-25 from Rikengreen Co., Ltd., ALFINE 83 from Taimei Chemicals Co., Ltd., and products for similar application from other manufacturers, and products of various grades are easily obtainable.

Specific examples of the water-soluble metal compound other than the aluminum compound include calcium acetate, calcium chloride, calcium formate, calcium sulfate, calcium butyrate, barium acetate, barium sulfate, barium phosphate, barium oxalate, barium naphthoresorcinol dicarboxylic acid, barium butyrate, manganese chloride, manganese acetate, manganese formate dihydrate, manganese ammonium sulfate hexahydrate, cupric chloride, ammonium cupric chloride dihydrate, copper sulfate, cupric butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, nickel ammonium sulfate hexahydrate, nickel amide sulfate tetrahydrate, nickel sulfamate, nickel 2-ethylhexanoate, ferrous bromide, ferrous chloride, ferric chloride, ferrous sulfate, ferric sulfate, ferric citrate, ferric lactate trihydrate, triammonium ferric trioxalate trihydrate, zinc bromide, zinc chloride, zinc nitrate hexahydrate, zinc sulfate, zinc acetate, zinc lactate, zirconyl acetate, zirconium tetrachloride, zirconium chloride, zirconium chloride oxide octahydrate, zirconium oxychloride, chromium acetate, chromium sulfate, sodium phosphotungstate, sodium tungsten citrate, dodecatungstophosphate n-hydrate, dodecatungstosilicate 26-hydrate, molybdenum chloride, dodecamolybdophosphate n-hydrate, aluminum alum, basic poly aluminum hydroxide, zinc phenolsulfonate, zinc ammonium acetate, and zinc ammonium carbonate.

Preferable examples of the water-soluble compounds containing a metal belonging to group 4A of the periodic table include titanium-containing water-soluble compounds and zirconium-containing water-soluble compounds. Examples of titanium-containing water-soluble compounds include titanium chloride, titanium sulfate, titanium tetrachloride, tetraisopropyl titanate, titanium acetylacetonate, and titanium lactate. Examples of a zirconium-containing water-soluble compound include zirconium acetate, zirconyl acetate, zirconium chloride, zirconium hydroxychloride, zirconium nitrate, zirconyl nitrate, basic zirconium carbonate, zirconium hydroxide, zirconium lactate, zirconyl lactate, ammonium zirconium carbonate, potassium zirconium carbonate, ammonium zirconium carbonate, potassium zirconyl carbonate, zirconium sulfate, zirconium fluoride, zirconyl sulfate, and zirconyl fluoride.

As the mordant, a cationic polymer is also preferred. As the cationic polymer, for example, nitrogen-containing organic cationic polymers are preferred, and polymers having primary amino group, secondary amino group, tertiary amino group or a quaternary ammonium salt group is preferred. Examples of the nitrogen-containing organic cationic polymer include a nitrogen-containing organic cationic polymer that is a homopolymer of a monomer having primary to tertiary amino group or a salts thereof or a quaternary ammonium salt group (nitrogen-containing organic cationic monomer), a nitrogen-containing organic cationic polymer obtained as a copolymer or a polycondensate of the above-mentioned nitrogen-containing organic cationic monomer and one of more other monomers, and a nitrogen-containing organic cationic polymer obtained by cationizing, by using a compound containing a cationic group, an urethane polymer having urethane bonds.

Among the cationic polymers, from the viewpoint of suppressing bleeding, cationic polyurethane and cationic polyacrylate described in JP-A No. 2004-167784 are preferred, and cationic polyurethane is more preferred. Examples of the commercially available product of the cationic polyurethane include “SUPER FLEX 650-5”, “F-8564D”, “F-8570D” (manufactured by Dai-Ichi Kogyo Seiyaku Co., Ltd.), and NEOFIX IJ-150 (manufactured by Nicca Chemical Co., Ltd.).

In the present invention, from the viewpoints of the density of printed image and the water resistance, a water-soluble aluminum compound, a water-soluble zirconium compound or a cationic polyurethane is preferred as the mordant.

The content of the mordant in the ink-receiving layer is preferably from 0.1% by mass to 10% by mass, and more preferably from 0.5% by mass to 8% by mass with respect to the inorganic fine particles from the standpoints of the density of printed image and the water resistance.

(Other Components)

The ink-receiving layer in the present invention may include the following components if necessity.

That is, the ink-receiving layer may include an anti-fading agent such as a variety of ultraviolet absorbents, antioxidants, and singlet oxygen quenchers, for the purpose of suppressing degradation of ink color materials.

Examples of the ultraviolet absorbent include cinnamic acid derivative, benzophenone derivative, and benzotriazolylphenol derivative. Specific examples thereof include butyl α-cyano-phenyl cinnamate, o-benzo triazolylphenol, o-benzo triazole-p-chlorophenol, o-benzo trizole-2,4-di-t-butylphenol, and o-benzo triazole-2,4-di-t-octylphenol. A hindered phenol compound also can be used as the ultraviolet absorbent, and specifically, a phenol derivative in which at least one or more of the position two and position six are substituted with branched alkyl groups is preferred.

A fluorescent brightener can also be used as the ultraviolet absorbent, and examples of the fluorescent brightener include a coumalic fluorescent brightener. Examples thereof are described, for example, in JP-B No. 45-4699 and JP-B No. 54-5324.

Specific examples of the antioxidant include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

The anti-fading agent may be used alone, or two or more thereof may be used in combination. The anti-fading agent may be water-solubilized, dispersed, or emulsified, and may be contained in a micro capsule. The amount of the anti-fading agent to be added is preferably from 0.01% by mass to 10% by mass of the ink-receiving-layer-forming liquid.

In the present invention, the ink-receiving layer preferably contains a high-boiling-point organic solvent for prevention of curling. The high-boiling-point organic solvent is preferably water-soluble, and examples of the water-soluble high-boiling-point organic solvent include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, polyethylene glycol (weight-average molecular weight of 400 or less), and diethylene glycol monobutyl ether (DEGMBE) is preferred.

The content of the high-boiling-point organic solvent in a ink-receiving layer-forming liquid is preferably from 0.05% by mass to 1% by mass, and particularly preferably from 0.1% by mass to 0.6% by mass.

The ink-receiving layer may contain, for example, various inorganic salts and acid or alkali as a pH adjuster for the purpose of increasing a dispersibility of the inorganic fine particles.

The ink-receiving layer may also contain metal oxide fine particles having electroconductivity for the purpose of suppressing the electrification of the surface of the ink-receiving layer due to the friction or separation, and various matt agents for the purpose of reducing friction at the surface of the ink-receiving layer.

(Method of Manufacturing Ink Jet Recording Medium)

A method of manufacturing the ink jet recording medium according to the present invention includes at least forming an undercoat layer by applying an undercoat-layer-coating liquid which contains a cationic polyvinyl alcohol on a gas impermeable support (undercoat layer forming process) and forming an ink-receiving layer by applying an ink-receiving-layer-coating liquid which contains inorganic fine particles and a water-soluble resin on the undercoat layer (ink-receiving layer forming process).

By the method of manufacturing the ink jet recording medium according to the present invention, the above described ink jet recording medium according to the present invention can be manufactured.

Hereinafter, each process in the present invention is described in detail.

### <Undercoat Layer Forming Process>

The undercoat layer forming process is a process of forming an undercoat layer by applying an undercoat-layer-coating liquid which contains a cationic polyvinyl alcohol on a gas impermeable support.

(Undercoat-Layer-Coating Liquid)

The cationic polyvinyl alcohol contained in the undercoat-layer-coating liquid may be the same as the one described in the section of the ink jet recording medium, and the preferable examples and amount thereof are also the same.

The content of the cationic polyvinyl alcohol in the undercoat-layer-coating liquid can be adjusted such that the content of the cationic polyvinyl alcohol in the undercoat layer after application of the undercoat-layer-coating liquid is in a range of from 0.01 g/m² to 1 g/m², preferably from 0.02 g/m² to 0.5 g/m², and more preferably from 0.05 g/m² to 0.5 g/m². The content of the cationic polyvinyl alcohol in the undercoat layer being in the above range is favorable, from the standpoints of improving adhesion of the undercoat layer to the ink-receiving layer and suppressing surface defects and bleeding.

In the undercoat-layer-coating liquid, water, an organic solvent, or the mixture thereof can be used as a solvent. Examples of the organic solvent that is usable for application include alcohols such as methanol, ethanol, n-propanol, i-propanol, and methoxy propanol; ketones such as acetone and methyl ethyl ketone; tetrahydrofuran, acetonitrile, ethyl acetate, and toluene. Among the organic solvents, from the viewpoint of suppressing surface defects of the ink jet recording medium, alcohol and a mixed solvent of alcohol and water are preferred, and methanol and a mixed solvent of methanol and water are more preferred. The mixed mass ratio of methanol to water is not particularly limited, but is preferably from 1:10 to 10:1 from the viewpoint of improving the application speed of the undercoat-layer-coating liquid.

The solid content concentration of the undercoat-layer-coating liquid is preferably in a range of from 0.1% by mass to 20% by mass, and more preferably in a range of from 0.5% by mass to 10% by mass.

Application of the undercoat-layer-coating liquid may be performed by a known application method. Examples of the known application method include methods using an apparatus such as an extrusion die coater, an air doctor coater, a blade coater, a rod coater, a knife coater, a squeeze coater, a reverse roll coater, or a bar coater.

The amount of the undercoat-layer-coating liquid to be applied is preferably from 1 ml/m² to 15 ml/m², more preferably from 1 ml/m² to 10 ml/m², and particularly preferably from 2 ml/m² to 8 ml/m², from the standpoint of productivity.

Drying of the undercoat-layer-coating liquid after application thereof is preferably performed at a temperature of from 20° C. to 100° C. for from 10 seconds to 5 minutes (particularly for from 20 seconds to 3 minutes). Although the drying time naturally varies according to the application amount, the range specified above is appropriate.

(Gas Impermeable Support)

The support used in the method of manufacturing the ink jet recording medium according to the present invention may be the same as the one described in the section of the ink jet recording medium, and the preferable examples are also the same.

<Ink-Receiving Layer Forming Process>

The ink-receiving layer-forming process is a process of forming the ink-receiving layer by applying the ink-receiving-layer-coating liquid which contains the inorganic fine particles and the water-soluble resin on the undercoat layer.

The ink jet recording medium according to the present invention may be manufactured by, for example, applying and drying the ink-receiving-layer-coating liquid on the undercoat layer, either after forming the undercoat layer by application and drying of the above-described undercoat-layer-coating liquid on the gas impermeable support, or at the same time as application of the undercoat-layer-coating liquid.

(Ink-Receiving-Layer-Coating Liquid)

The ink-receiving-layer-coating liquid may contain the inorganic fine particles and the water-soluble resin, which have been described in the section of the ink-receiving layer of the ink jet recording medium, and the preferable examples and amount thereof are also the same as described in the section.

The ink-receiving-layer-coating liquid may be prepared, for example, in the following manner. Fine particles (silica fine particles) and the zirconium compound are dispersed by counter collision using a high-pressure disperser or by allowing them to pass through an orifice, so as to prepare a silica dispersion liquid, and then the water-soluble resin is added to the silica dispersion liquid.

The inorganic dispersion liquid (silica dispersion liquid) prepared by counter collision of the inorganic fine particles and the zirconium compound or the inorganic fine particles, the zirconium compound and the crosslinking agent, using a high-pressure disperser or by allowing them to pass through an orifice is excellent since the diameters of the inorganic fine particles are small.

The inorganic fine particles and the zirconium compound or the inorganic fine particles, the zirconium compound and the crosslinking agent are processed by the high-pressure disperser in a form of a dispersion liquid (preliminary dispersion liquid). Preliminary mixing (preliminary dispersing) may be performed by general propeller agitation, turbine agitation, homomixer agitation, or the like.

As the high-pressure disperser used for the preparation of the dispersion liquid, a commercially available apparatus, which is generally called a high-pressure homogenizer, may be suitably used.

Typical examples of the high-pressure homogenizer include NANOMIZER (manufactured by Nanomizer Inc.), MICROFLUIDIZER (manufactured by Microfludics Corporation), and ULTIMIZER (manufactured by Sugino Machine Limited).

The orifice refers to a structure in which a thin plate having a fine hole of circular shape or the like (orifice plate) is placed in a straight pipe so that the flow channel in the straight pipe abruptly narrows at the fine hole.

The high-pressure homogenizer basically includes a high-pressure generation unit that applies a pressure to a raw slurry or the like, and a counter collision unit or an orifice unit. As the high-pressure generation unit, a high-pressure pump which is generally called a plunger pump is favorably employed. There are various kinds of high-pressure pumps such as single, double, and triple pumps, and any of these may be employed in the present invention without particular limitation.

When the counter collision at high pressure is performed, the process pressure may be 50 MPa or more, preferably 100 MPa or more, and still more preferably 130 MPa or more.

When the dispersing is performed by passing through the orifice, the difference between the pressure at an entrance and the pressure at an exit of the orifice may be, similar to the above process pressure, 50 MPa or more, preferably 100 MPa or more, and still more preferably 130 MPa or more.

When the preliminary dispersion liquid is subjected to counter collision, the collision speed of the preliminary dispersion liquid as a relative speed is preferably 50 m/sec. or more, more preferably 100 m/sec. or more, and still more preferably 150 m/sec or more.

The linear speed of a solvent when passing through the orifice cannot be determined unconditionally because the linear speed is determined depending on the diameter of the orifice to be used. However, similar to the collision speed of the counter collision, the linear speed is preferably 50 m/sec. or more, more preferably 100 m/sec. or more, and still more preferably 150 m/sec or more.

In any of the above-mentioned methods, dispersion efficiency depends on the process pressure, therefore, a higher process pressure leads to a higher dispersion efficiency. However, when the process pressure exceeds 350 MPa, it is highly likely that problems occur in pressure resistance of the piping and the like of the high-pressure pump and in durability of the apparatus.

In any of the above-mentioned methods, the number of times the treatment is performed is not particularly limited, and, in general, is appropriately selected from a range of once to several tens of times. As a result, the dispersion can be obtained.

In the preparation of the dispersion liquid, various additives may be added to the dispersion liquid.

Examples of the additives include various nonionic or cationic surfactants (anionic surfactants are not favorable due to formation of aggregates), defoamers, nonionic hydrophilic polymers (such as polyvinyl alcohol, polyvinyl pyrrolidone, polyethylene oxide, polyacrylamide, various saccharides, gelatin, and pullulan), nonionic or cationic latex dispersion liquids, water-miscible organic solvents (such as ethyl acetate, methanol, ethanol, isopropanol, n-propanol, and acetone), inorganic salts, and pH adjusters, and any of these additives may be appropriately used as necessary.

In particular, the water-miscible organic solvent is preferable from the standpoint of suppressing formation of minute lumps when the inorganic fine particles (silica) or the like have been preliminary dispersed. The water-miscible organic solvent may be used at a content of from 0.1% by mass to 20% by mass, and particularly preferably from 0.5% by mass to 10% by mass in the dispersion liquid.

The pH at the preparation of the inorganic fine particles (fumed silica) dispersion liquid may widely vary depending on the kind of the inorganic fine particles (fumed silica) or various additives. In general, the pH is from 1 to 8, and particularly preferably from 2 to 7. It is also possible to concurrently use two or more additives when the dispersing is performed.

In the method of manufacturing the ink jet recording medium according to the present invention, polyvinyl alcohol or the like is added to the thus-obtained dispersion liquid, whereby the ink-receiving layer-forming liquid can be obtained. The dispersion liquid and polyvinyl alcohol, and other ingredients if any, may be mixed by general propeller agitation, turbine agitation, homomixer agitation, or the like.

In the method of manufacturing the ink jet recording medium according to the present invention, the water-soluble aluminum compound and the ink-receiving layer-forming liquid may be mixed by in-line mixing. Examples of in-line mixing apparatuses that may be used in the in-line mixing include those described in JP-A No. 2002-85948, but are not limited thereto.

In a case in which the water-soluble aluminum compound is added to the ink-receiving layer-forming liquid, the method of manufacturing the ink jet recording medium according to the present invention may further include applying, onto a coating layer formed by applying an ink-receiving layer-forming mixed liquid obtained by in-line mixing of the ink-receiving layer-forming liquid and the water-soluble aluminum compound onto the undercoat layer, a basic solution having a pH of 7.1 or higher either (1) at the same time as applying the ink-receiving layer-forming mixed liquid prepared or (2) during drying of the coating layer but before the coating layer exhibits falling-rate drying, thereby crosslinking and curing the coating layer to form a crosslink-cured ink-receiving layer.

Provision of the ink-receiving layer crosslinked and cured as described above and containing the water-soluble aluminum compound is preferable from the viewpoints of improving ink absorbency, preventing cracks in films, and the like.

In the method of manufacturing the ink jet recording medium according to the present invention, water, an organic solvent, or a mixture thereof may be used as a solvent in each process. Examples of the organic solvent that can be used include alcohols such as methanol, ethanol, n-propanol, i-propanol, and methoxypropanol; ketones such as acetone and methyl ethyl ketone; tetrahydrofuran; acetonitrile; ethyl acetate; and toluene.

Application of the ink-receiving layer-forming liquid may be performed by a known application method. Examples of the known application methods include methods using an apparatus such as an extrusion die coater, an air doctor coater, a blade coater, a rod coater, a knife coater, a squeeze coater, a reverse roll coater, or a bar coater.

The basic solution having a pH of 7.1 or higher is preferably applied to the coating layer, either (i) at the same time as the application of the ink-receiving layer-forming mixed liquid containing the water-soluble aluminum compound or (ii) during drying of the coating layer formed by applying the ink-receiving layer-forming mixed liquid containing the water-soluble aluminum compound but before the coating layer exhibits falling-rate drying. That is, the ink-receiving layer according to the invention is favorably manufactured by introducing a basic solution having a pH of 7.1 or higher (i) at the same time as the application of the ink-receiving layer-forming mixed liquid containing the water-soluble aluminum compound or (ii) after the application of the ink-receiving layer-forming mixed liquid but during the coating layer exhibits constant rate drying.

The basic solution having a pH of 7.1 or higher may contain a crosslinking agent or the like as necessary. The basic solution having a pH of 7.1 or higher can be used as an alkali solution so as to promote film-curing. The pH of the basic solution having a pH of 7.1 or higher is preferably a pH of 7.5 or higher, and more preferably a pH of 7.9 or higher. When the pH is too close to the acidic side, crosslinking reaction of the water-soluble resin (for example, polyvinyl alcohol) which is contained in the ink-receiving layer-forming liquid is not sufficiently conducted by the crosslinking agent, whereby defects such as occurrence of bronzing or cracks in the ink-receiving layer may occur.

The basic solution having a pH of 7.1 or higher may be prepared by, for example, adding, into ion-exchange water, a metal compound (for example, 1% to 5%), a basic compound (for example, 1% to 5%), and para-toluene sulfonate (for example, 0.5% to 3%) as necessary, and then agitating the resultant mixture well. Here, the “%” for each composition refers to the % by mass of solid content.

Here, the expression “before the coating layer exhibits falling-rate drying” usually refers to a period of several minutes from immediately after the application of the ink-receiving layer-forming mixed liquid; during this period, the coating layer shows the phenomenon of “constant-rate drying” in which the solvent (dispersing medium) content in the applied coating layer decreases in proportion to the lapse of time. In regard to the time for such “constant-rate drying,” descriptions in, for example, Chemical Kagaku Kogaku Binran (Handbook of Chemical Technology), pages 707 to 712, published by Murazen Co., Ltd. on Oct. 25, 1980) may be referenced.

As is described above, after the application of the ink-receiving layer-forming mixed liquid, the coating layer is dried until the coating layer starts to exhibit falling-rate drying. The drying is generally conducted at a temperature of from 40° C. to 180° C. for 0.5 min. to 10 min. (preferably 0.5 min. to 5 min.). The drying of an ink-receiving layer-forming liquid other than the above-described ink-receiving layer-forming mixed liquid can be conducted under the same conditions as described above. Although the drying time naturally varies according to the application amount of the ink-receiving layer-forming (mixed) liquid, the range specified above is generally appropriate.

### EXAMPLES

Hereinafter, the present invention is specifically described with reference to examples, but the present invention is not limited to these examples. In addition, unless otherwise described, “part(s)” and “%” are mass-based.

### Example 1

### “Manufacturing of Support”

50 parts of LBKP obtained from acacia and 50 parts of LBKP obtained from aspen were respectively beaten to a Canadian Standard Freeness of 300 ml by a disk refiner so as to prepare a pulp slurry.

Next, to the pulp slurry obtained as described above, 1.3% of cationic starch (CAT0304L, manufactured by Nippon NSC), 0.15% of anionic polyacrylamide (POLYACRON ST-13, manufactured by Seiko Chemical Industries Co., Ltd.), 0.29% of alkylketene dimer (SIZEPINE K, manufactured by Arakawa Chemical Industries, Ltd.), 0.29% of epoxidized amide behenate and 0.32% of polyamide polyamine epichlorohydrin (ARAFIX 100, manufactured by Arakawa Chemical Industries, Ltd.) were added, and thereafter 0.12% of a defoamer was added thereto. The percentages above are percentages relative to the mass of the pulp.

The pulp slurry prepared as described above was used for paper making using a Gourdrinier paper machine. The felt face of the web was pressed against a drum dryer cylinder with a dryer canvas interposed therebetween with a tensile strength of the dryer canvas set at 1.6 Kg/cm, thereby drying the web. Then, polyvinyl alcohol (KL-118, manufactured by Kuraray Co., Ltd.) was coated on both sides of a base paper in an amount of 1 g/m² by size press, and then dried and calendared. The base paper was formed to have a basis weight of 157 g/m², and thus a base paper having a thickness of 157 μm (substrate paper) was obtained.

The wire face side (rear face) of the obtained substrate paper was subjected to corona discharge treatment. Thereafter, polyethylene prepared by blending high-density polyethylene/low-density polyethylene at a ratio of 80%/20% was coated on the wire face in a coating amount of 20 g/m² by melt extrusion at a temperature of 320° C. using a melt extruder, whereby a thermoplastic resin layer having matte surfaces was formed (hereinafter, the surface having the thermoplastic resin layer is referred to as a “rear face,” and the other surface is referred to as a “front face”.) The thermoplastic resin layer on the rear face was subjected to corona discharge treatment, and thereafter, a dispersion liquid in prepared by dispersing aluminum oxide (“ALUMNA ZOL 100,” manufactured by Nissan Chemical Industries, Ltd.) and silicon dioxide (“SNOWTEX O,” manufactured by Nissan Chemical Industries, Ltd.) at a mass ratio of 1:2 as antistatic agents in water was applied in a dry mass of 0.2 g/m². Subsequently, the front face was subjected to corona discharge treatment, and then, polyethylene having a density of 0.93 g/m³ which included 10% by mass of titanium oxide was coated thereon in an amount of 24 g/m² by melt extrusion at a temperature of 320° C. using a melt extruder, whereby a support (polyolefin resin-coated paper: WP paper) was obtained.

<Manufacturing of Ink-Receiving Layer-Forming Liquid A>

According to the following composition of “silica dispersion liquid A”, silica fine particles were mixed with a liquid obtained by mixing a dimethyl diallyl ammonium chloride polymer (SHAROL DC 902P, manufactured by Dai-Ichi Kogyo Seiyaku Co., Ltd.) with ion-exchange water. Then, ZIRCOSOL ZA-30 (manufactured by Dai-ichi Kigenso Kagaku Kogyo Co., Ltd.) was further added thereto. The resulting slurry was further subjected to dispersion using an ULTIMIZER (manufactured by Sugino Machine Limited) under a pressure of 170 MPa, whereby silica dispersion liquid A including silica fine particles having a median diameter (average particle diameter) of 120 nm was obtained.

According to the following “composition of the ink-receiving layer-forming liquid A”, ion-exchange water, 7.5% boric acid liquid, SC-505, a polyvinyl alcohol solution, and SUPER FLEX 650-5 were sequentially added to the silica dispersion liquid A, followed by mixing, whereby an ink-receiving layer-forming liquid A was prepared.

“Silica Dispersion Liquid A”

| | | |
|---|---|---|
| (1) | Fumed silica fine particles | 15.0 parts |
| | (AEROSIL 300SF75, manufactured by Nippon | |
| | Aerosil Co., Ltd.) | |
| (2) | Ion-exchange water | 82.9 parts |
| (3) | “SHAROLL DC-902P” (51.5% solution) | 1.31 parts |
| | (dispersant, manufactured by Dai-Ichi Kogyo | |
| | Seiyaku Co., Ltd.) | |
| (4) | Zirconyl acetate “ZIRCOSOL ZA-30 (50% solution)” | 0.81 parts |
| | (manufactured by Dai-ichi Kigenso Kagaku Kogyo | |
| | Co., Ltd.) | |

“Composition of the Ink-Receiving Layer-Forming Liquid A”

| | |
|---|---|
| (1) Silica dispersion liquid A | 59.5 parts |
| (2) Ion-exchange water | 7.8 parts |
| (3) 7.5% boric acid liquid (crosslinking agent) | 4.4 parts |
| (4) Dimethylamine epichlorohydrin•polyalkylene | 0.1 parts |
| polyamine polycondensate (50% solution) | |
| (SC-505, manufactured by Hymo Co., Ltd.) | |
| (5) Polyvinyl alcohol solution described below | 26.0 parts |
| (6) Cationized polyurethane | 2.2 parts |
| (SUPER FLEX 650-5 (25% liquid)) | |
| (manufactured by Dai-Ichi Kogyo Seiyaku Co., Ltd.) | |

<Composition of Polyvinyl Alcohol Solution>

| | |
|---|---|
| (1) Polyvinyl alcohol | 6.96 parts |
| (“JM-33,” manufactured by Japan Vam & Poval Co., Ltd., | |
| degree of saponification: 94.3 mol %, degree of | |
| polymerization: 3300) | |
| (2) Polyoxyethylene laurylether | 0.23 parts |
| (EMALGEN 109P, surfactant, manufactured by Kao | |
| Corporation) | |
| (3) Diethylene glycol monobutyl ether | 2.12 parts |
| (BUTYCENOL 20P, manufactured by Kyowa Hakko | |
| Chemical Co., Ltd.) | |
| (4) Ion-exchange water | 90.69 parts |

(Manufacturing of Ink Jet Recording Medium)

After conducting corona discharge treatment on the front surface of the support, the following undercoat-layer-coating liquid was applied at an amount of 4 ml/m² (cationic polyvinyl alcohol: 0.16 g/m²) and dried at 70° C. for 1 minute (film thickness: 0.16 μm).

Furthermore, the ink-receiving layer-forming liquid A and the PAC liquid 1 described below were inline-blended, and the blended liquid was coated on the front surface using an extrusion die coater such that a coating amount of the ink-receiving layer-forming liquid A was 183 g/m² and that of the PAC liquid 1 was 11.4 g/m². Thereafter, the resulting coating layer was dried at 5° C. and 30% relative humidity using a cold air dryer (at an air flow rate of from 3 m/sec to 8 m/sec) for 5 minutes, and was further dried with dry air having a temperature of 25° C. and a relative humidity of 25% (at an air flow rate of from 3 m/sec to 8 m/sec) for 20 minutes. The coating layer exhibited constant-rate drying in this period. Before exhibiting falling rate-drying, the coating layer was immersed in a basic solution (pH=7.8) of the following composition for 3 seconds, as a result of which, the basic solution was adhered on the coating layer such that the coating amount of the basic solution was 13 g/m², and this was further dried at 65° C. for 10 minutes (curing process). Thereby, the ink jet recording medium according to the present invention having the ink-receiving layer with a dry layer thickness of 30 μm was manufactured.

<Composition of Undercoat-Layer-Coating Liquid>

| | |
|---|---|
| (1) Cationic polyvinyl alcohol (K-210, manufactured by | 4 parts |
| Nippon Synthetic Chemical Industry Co., Ltd.) | |
| (2) Methanol | 50.0 parts |
| (3) Ion-exchange water | 46.0 parts |

<PAC Liquid 1>

| | |
|---|---|
| (1) Poly aluminum chloride aqueous solution having a degree | 20 parts |
| of basicity of 83% (ALFINE 83, manufactured by Daimei | |
| Chemicals Co., Ltd.) | |
| (2) Ion-exchange water | 80 parts |

<Composition of Basic Solution>

| | |
|---|---|
| (1) Boric acid | 0.65 parts |
| (2) Ammonium carbonate (first grade) (manufactured by | 3.5 parts |
| Kanto Kagaku) | |
| (3) Ion-exchange water | 63.6 parts |
| (4) Polyoxyethylene laurylether (2% aqueous solution) | 30.0 parts |
| (EMALGEN 109P, surfactant, manufactured by Kao | |
| Corporation) | |

### Example 2

An ink jet recording medium was manufactured in the same manner as in Example 1 except that the cationic polyvinyl alcohol was changed to C-506 (manufactured by Kuraray Co., Ltd.).

### Example 3

An ink jet recording medium was manufactured in the same manner as in Example 1 except that the cationic polyvinyl alcohol was changed to CM-318 (manufactured by Kuraray Co., Ltd.).

### Example 4

An ink jet recording medium was manufactured in the same manner as in Example 1 except that the methanol was changed to ion-exchange water.

### Example 5

An ink jet recording medium was manufactured in the same manner as in Example 1 except that the methanol was changed to propanol.

### Example 6

An ink jet recording medium was manufactured in the same manner as in Example 1 except that the amount of the undercoat-layer-coating liquid to be applied was changed from 4 ml/m² to 22.5 ml/m².

### Example 7

An ink jet recording medium was manufactured in the same manner as in Example 1 except that the amount of the undercoat-layer-coating liquid to be applied was changed from 4 ml/m² to 1.25 ml/m².

### Comparative Example 1

An ink jet recording medium was manufactured in the same manner as in Example 1 except that the cationic polyvinyl alcohol was changed to PVA-217 (manufactured by Kuraray Co., Ltd.).

### Comparative Example 2

An ink jet recording medium was manufactured in the same manner as in Example 1 except that the undercoat-layer-coating liquid was not applied.

### Comparative Example 3

An ink jet recording medium was manufactured in the same manner as in Example 1 except that both surfaces of the base paper (substrate paper) were not coated by extrusion in manufacturing the support.

### Comparative Example 4

An ink jet recording medium was manufactured in the same manner as in Example 1 except that the cationic polyvinyl alcohol was changed to lime-treated gelatin.

### Comparative Example 5

An ink jet recording medium was manufactured in the same manner as in Example 1 except that the cationic polyvinyl alcohol was changed to KL-118 (manufactured by Kuraray Co., Ltd.).

### Comparative Example 6

An ink jet recording medium was manufactured in the same manner as in Example 1 except that the amount of the undercoat-layer-coating liquid to be applied was changed from 4 ml/m² to 40 ml/m².

The following evaluation was conducted for the ink jet recording sheets obtained above. Results are shown in Table 1.

Image Clarity

Based on the image clarity test method defined in JIS H8686-2 (1999), the image clarity was measured and evaluated using an image clarity measuring apparatus ICM-1 (manufactured by Suga Test Instruments Co., Ltd.) under the following measurement and analysis conditions.

### <Measurement Conditions>

• Measurement method: reflection • Measurement angle: 60° • Optical comb: 2.0 mm,

### Evaluation Criteria

A: The image clarity is 80% or more.
B: The image clarity is from 70% to less than 80%.
C: The image clarity is from 30% to less than 70%.
D: The image clarity is less than 30%.

Surface Defects

The surface conditions of the front surface of the obtained ink jet recording sheet were observed visually, and the number of crack defects in an area of 1 m² was evaluated according to the following criteria.

### Evaluation Criteria

A: No crack or surface defect is observed.
B: No crack is observed, but one or two abnormal glosses induced by expansion of the ink-receiving layer are observed. However, it is a practically acceptable level.
C: 3 to 10 cracks are observed, which is a practically problematic level.
D: More than 10 cracks are observed, which is a practically problematic level.

Bleeding

A grid-shaped linear pattern (with a line width of 0.28 mm) with a magenta ink and a black ink being located adjacently was printed on each ink jet recording sheet using an ink jet printer (trade name: MP-950, manufactured by Cannon Inc.). The resulting printed ink jet recording sheet was stored in a tank with a constant temperature and humidity at 23° C. and a relative humidity of 90% for 14 days. Thereafter, bleeding (bleeding over time) was evaluated based on the following criteria.

### Evaluation Criteria

A: Occurrence of bleeding over time is hardly observed, thus being satisfactory.
B: Slight bleeding over time is observed, which is a practically problematic level.
C: Bleeding over time was remarkably observed, which is a practically problematic level.

TABLE 1

| | | | | | | | | | Com- | Com- | Com- | Com- | Com- | Com- |
|---|---|---|---|---|---|---|---|---|---|---|---|---|---|---|
| | | | | | | | | | parative | parative | parative | parative | parative | parative |
| | | Ex- | Ex- | Ex- | Ex- | Ex- | Ex- | Ex- | ex- | ex- | ex- | ex- | ex- | ex- |
| | | ample | ample | ample | ample | ample | ample | ample | ample | ample | ample | ample | ample | ample |
| | | 1 | 2 | 3 | 4 | 5 | 6 | 7 | 1 | 2 | 3 | 4 | 5 | 6 |
| Support | | WP | WP | WP | WP | WP | WP | WP | WP | WP | Paper | WP | WP | WP |
| | | paper | paper | paper | paper | paper | paper | paper | paper | paper | | paper | paper | paper |
| Under | Binder | K-210 | C-506 | CM-318 | K-210 | K-210 | K-210 | K-210 | PVA-217 | — | K-210 | Gelatin | KL-118 | K-210 |
| coat | | Cat- | Cat- | Cat- | Cat- | Cat- | Cat- | Cat- | — | — | Cat- | — | Anionic | Cat- |
| layer | | ionic | ionic | ionic | ionic | ionic | ionic | ionic | | | ionic | | | ionic |
| | Content of | 0.16 | 0.16 | 0.16 | 0.16 | 0.16 | 0.9 | 0.05 | 0.16 | — | 0.16 | 0.16 | 0.16 | 1.6 |
| | cationic | | | | | | | | | | | | | |
| | PVA | | | | | | | | | | | | | |
| | (g/m²) | | | | | | | | | | | | | |
| | Solvent | Meth- | Meth- | Meth- | Ion- | Pro- | Meth- | Meth- | Meth- | — | Meth- | Meth- | Meth- | Meth- |
| | | anol | anol | anol | exchange | panol | anol | anol | anol | | anol | anol | anol | anol |
| | | | | | water | | | | | | | | | |
| | Thickness | 0.16 | 0.16 | 0.16 | 0.16 | 0.16 | 0.9 | 0.05 | 0.16 | — | 0.16 | 0.16 | 0.16 | 1.6 |
| | (μm) | | | | | | | | | | | | | |

| | | | | | | | | | | | | | |
|---|---|---|---|---|---|---|---|---|---|---|---|---|---|
| Surface defects | A | A | A | B | A | A | B | C | D | A | C | D | A |
| Image clarity | A | A | A | A | B | A | A | A | A | C | A | A | A |
| Bleeding | A | A | A | A | A | B | A | A | A | A | A | A | C |

* WP paper: Polyethylene resin-coated paper

As shown in Table 1, the ink jet recording medium according to the present invention is excellent in terms of image clarity and, particularly, shows a small number of surface defects, thereby being satisfactory.

According to the present invention, there is provided an ink jet recording medium having excellent image clarity and reduced surface defects, and a method of manufacturing an ink jet recording medium having excellent image clarity and suppressed occurrence of surface defects even when high-speed coating is conducted.

Embodiments of the present invention include, but are not limited to, the following.

<1> An ink jet recording medium comprising:

a gas impermeable support,

an undercoat layer that is provided on the gas impermeable support and contains from 0.01 g/m² to 1 g/m² of cationic polyvinyl alcohol, and

an ink-receiving layer that is provided on the undercoat layer and contains inorganic fine particles and a water-soluble resin.

<2> The ink jet recording medium according to <1>,

wherein the molar ratio of cationic groups present in the cationic polyvinyl alcohol relative to the total mole number of structural units constituting the cationic polymer is from 0.01 mol % to 20 mol %.

<3> The ink jet recording medium according to <1> or <2>,

wherein the thickness of the undercoat layer is from 0.01 μm to 1 μm.

<4> The ink jet recording medium according to any one of <1> to <3>,

wherein the gas impermeable support is a polyolefin resin-coated paper.

<5> The ink jet recording medium according to any one of <1> to <4>,

wherein the content ratio (x/y) of the mass of the inorganic fine particles (x) with respect to 1 part by mass of the water-soluble resin (y) is from 1.5/1 to 10/1.

<6> The ink jet recording medium according to any one of <1> to <5>,

wherein the ink-receiving layer further include a crosslinking agent.

<7> A method of manufacturing an ink jet recording medium comprising:

forming an undercoat layer by applying an undercoat-layer-coating liquid containing cationic polyvinyl alcohol on a gas impermeable support; and

forming an ink-receiving layer by applying an ink-receiving-layer-coating liquid containing inorganic fine particles and a water-soluble resin on the undercoat layer.

<8> The method of manufacturing an ink jet recording medium according to <7>,

wherein the undercoat-layer-coating liquid contains an additional alcohol other than the cationic polyvinyl alcohol.

<9> The method of manufacturing an ink jet recording medium according to <7>,

wherein the undercoat-layer-coating liquid contains a mixed solvent of the additional alcohol and water.

<10> The method of manufacturing an ink jet recording medium according to <8> or <9>,

wherein the additional alcohol is methanol.

<11> The method of manufacturing an ink jet recording medium according to any one of <7> to <10>,

wherein the thickness of the undercoat layer is 0.01 μm to 1 μm.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink jet recording medium comprising:
a gas impermeable support,
an undercoat layer that is provided on the gas impermeable support and contains from 0.01 g/m² to 1 g/m² of cationic polyvinyl alcohol, and
an ink-receiving layer that is provided on the undercoat layer and contains inorganic fine particles and a water-soluble resin.

2. The ink jet recording medium according to claim 1,
wherein the molar ratio of cationic groups present in the cationic polyvinyl alcohol relative to the total mole number of structural units constituting the cationic polymer is from 0.01 mol % to 20 mol %.

3. The ink jet recording medium according to claim 1,
wherein the thickness of the undercoat layer is from 0.01 μm to 1 μm.

4. The ink jet recording medium according to claim 1,
wherein the gas impermeable support is a polyolefin resin-coated paper.

5. The ink jet recording medium according to claim 1,
wherein the content ratio (x/y) of the mass of the inorganic fine particles (x) with respect to 1 part by mass of the water-soluble resin (y) is from 1.5/1 to 10/1.

6. The ink jet recording medium according to claim 1,
wherein the ink-receiving layer further includes a crosslinking agent.

7. A method of manufacturing an ink jet recording medium comprising:
forming an undercoat layer by applying an undercoat-layer-coating liquid containing cationic polyvinyl alcohol on a gas impermeable support; and
forming an ink-receiving layer by applying an ink-receiving-layer-coating liquid containing inorganic fine particles and a water-soluble resin on the undercoat layer.

8. The method of manufacturing an ink jet recording medium according to claim 7,
wherein the undercoat-layer-coating liquid contains an additional alcohol other than the cationic polyvinyl alcohol.

9. The method of manufacturing an ink jet recording medium according to claim 7,
wherein the undercoat-layer-coating liquid contains a mixed solvent of the additional alcohol and water.

10. The method of manufacturing an ink jet recording medium according to claim 8,
wherein the additional alcohol is methanol.

11. The method of manufacturing an ink jet recording medium according to claim 7,
wherein the thickness of the undercoat layer is 0.01 μm to 1 μm.
